(19) United States
(12) Patent Application Publication
(10) Pub. No.: US 2017/0199934 A1
(43) Pub. Date: Jul. 13, 2017

(54) METHOD AND APPARATUS FOR AUDIO SUMMARIZATION

(71) Applicant: Google Inc., Mountain View, CA (US)

(72) Inventors: Rajeev Conrad Nongpiur, Palo Alto, CA (US); Akshay Bapat, Mountain View, CA (US); Lawrence Wayne Neal, Palo Alto, CA (US)

(21) Appl. No.: 14/992,700

(22) Filed: Jan. 11, 2016

(51) Int. Cl. G06F 17/30; G06F 3/16; G10L 19/018

(52) U.S. Cl. CPC G06F 17/30769; G06F 17/30743; G06F 17/30766; G10L 19/018; G06F 3/165

(57) ABSTRACT

Summaries of audio or audio-video events are created from audio or audio-video recordings based on the needs of a particular user. The summarized events may have shorter timespans than the actual timespans of audio or audio-video recordings. Audio or audio-video recordings may be provided by one or more recording devices or sensors to a network, such as a cloud. A summarizer is provided in the network, and may include an audio marker, an audio enhancer, and an audio compiler. The audio marker tags segments of an audio or audio-video stream using one or more audio detectors based on user preferences. The audio enhancer may enhance the quality of tagged audio segments by enhancing desired sound features and suppressing undesired sound features. The audio compiler compiles the tagged audio segments based on event scores and generates audio or audio-video summaries for the user.

### BACKGROUND

Various systems and techniques exist for capturing audiovisual data of a region and reviewing the data at a later time. For example, closed-circuit cameras and other security systems often are connected to recording systems that allow for an operator to review any audio and/or video captured by the security system at a later date. Typically, the operator reviews such stored information by viewing the data at a normal speed, i.e., the speed at which any events captured by the security camera occurred originally. In some cases, an operator may be able to review captured data at a higher rate, for example, by fast-forwarding through a recorded video. Such techniques may allow for faster review of captured data.

### BRIEF SUMMARY

According to an embodiment of the disclosed subject matter, a method of audio summarization includes obtaining a user preference indicating a sound signature of interest to a user, generating one or more designated audio segments of interest from an input audio stream based on the user preference, generating an event score for each of the designated audio segments of interest, the event score indicating the probability that an audio event associated with the sound signature occurs within the audio segment, and generating a summarized output audio stream by applying the event score to each of the designated audio segments of interest to emphasize sounds corresponding to the sound signature of interest to the user over sounds that do not correspond to the sound signature of interest to the user.

According to an embodiment of the disclosed subject matter, an apparatus for audio summarization includes a memory and a processor communicably coupled to the memory. In an embodiment, the processor is configured to execute instructions to obtain a user preference indicating a sound signature of interest to a user, to generate one or more designated audio segments of interest from an input audio stream based on the user preference, to generate an event score for each of the designated audio segments of interest, the event score indicating the probability that an audio event associated with the sound signature occurs within the audio segment, and to generate a summarized output audio stream by applying the event score to each of the designated audio segments of interest to emphasize sounds corresponding to the sound signature of interest to the user over sounds that do not correspond to the sound signature of interest to the user.

According to an embodiment of the disclosed subject matter, an apparatus for audio summarization includes an audio summarizer, which includes an audio marker configured to obtain a user preference indicating a sound signature of interest to a user and to generate one or more designated audio segments of interest from an input audio stream based on the user preference, and an audio compiler configured to generate an event score for each of the designated audio segments of interest, the event score indicating the probability that an audio event associated with the sound signature occurs within the audio segment, and to generate a summarized output audio stream by applying the event score to each of the designated audio segments of interest to emphasize sounds corresponding to the sound signature of interest to the user over sounds that do not correspond to the sound signature of interest to the user.

According to an embodiment of the disclosed subject matter, means for audio summarization are provided, which include means for obtaining a user preference indicating a sound signature of interest to a user, means for generating one or more designated audio segments of interest from an input audio stream based on the user preference, means for generating an event score for each of the designated audio segments of interest, the event score indicating the probability that an audio event associated with the sound signature occurs within the audio segment, and means for generating a summarized output audio stream by applying the event score to each of the designated audio segments of interest to emphasize sounds corresponding to the sound signature of interest to the user over sounds that do not correspond to the sound signature of interest to the user.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a block diagram illustrating an example of a network configuration for audio summarization according to embodiments of the disclosed subject matter.

FIG. 2 shows a block diagram illustrating an example of a summarizer according to embodiments of the disclosed subject matter.

FIG. 3 shows a block diagram illustrating an example of an audio summarizer according to embodiments of the disclosed subject matter.

FIG. 4 shows a block diagram illustrating an example of an audio marker according to embodiments of the disclosed subject matter.

FIG. 5 shows a flowchart illustrating an example of a process of generating a summarized output audio stream according to embodiments of the disclosed subject matter.

FIG. 6 shows an example of a computing device according to embodiments of the disclosed subject matter.

FIG. 7 shows an example of a sensor according to embodiments of the disclosed subject matter.

FIG. 8 shows an example of a sensor network according to embodiments of the disclosed subject matter.

### DETAILED DESCRIPTION

Conventional techniques for reviewing captured audio and/or video may be quite time-intensive, since even in a fast-forward mode a user may be required to “fast-forward” through a relatively large amount of data before identifying a segment of audio and/or video that is of interest. For example, where a user only wishes to view a period of time during which a particular sound was captured by an audio device, the user may be required to review a relatively large amount of captured audio to find the desired sound. Thus, according to implementations disclosed herein, it may be desirable to create summaries of sound events over a given timespan from pre-recorded audio or audio-video data. It also may be desirable to present an audio or audio-video event within a shorter timespan than the entire timespan of the audio or audio-visual event based on the need or desire of a specific user. For example, it may be desirable to present the user with enhanced relevant portions of an audio or audio-video event while eliminating or suppressing noises and other artifacts in a sound stream that are not included in the user's list of desirable types of sounds.

The presently-disclosed subject matter relates to methods and apparatus for creating summaries of sound events from an audio or audio-video recording. For example, summaries of sound events based on an audio or audio-video recording may be created based on the needs of a particular user, and such summaries of sound events may have a shorter timespan than the actual timespan of the audio or audio-video recording. As a specific example, upon receiving a user preference indicating a sound signature of interest, one or more designated audio segments of interest may be generated from an input audio stream based on the user preference. An event score may be generated to indicate the probability that an audio event associated with the sound signature occurs within the audio segment, and a summarized output audio stream may be generated by applying the event score to each of the designated audio segments of interest to emphasize sounds corresponding to the sound signature of interest to the user over sounds that do not correspond to the sound signature of interest to the user.

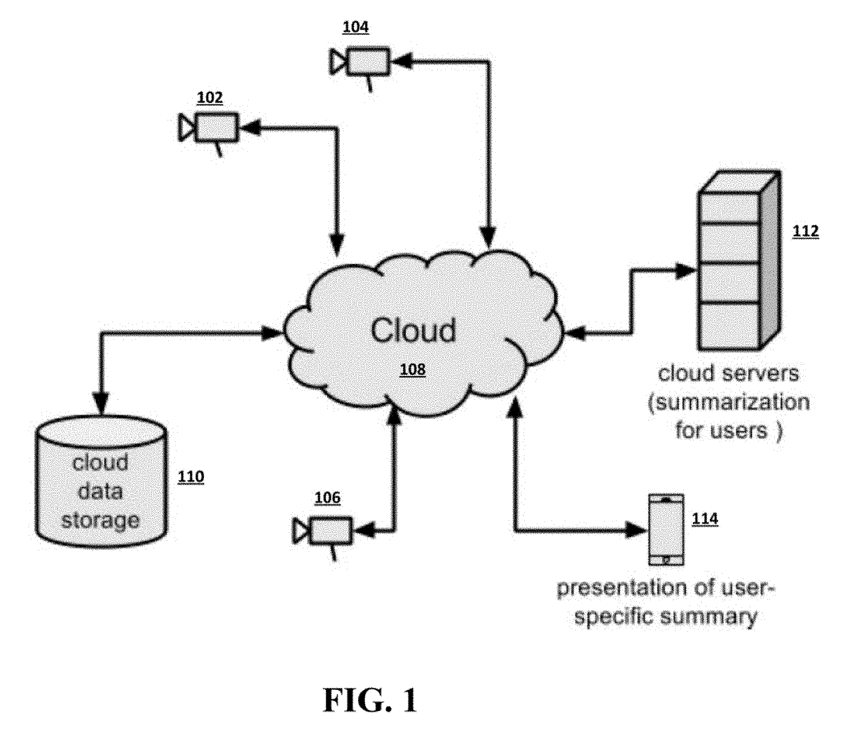

FIG. 1 shows a block diagram illustrating an example of a network configuration for audio summarization according to embodiments of the disclosed subject matter. In the example shown in FIG. 1, various devices 102, 104 and 106 are capable of recording audio or audio-video signals in digital format and transmitting audio or audio-video data to a network, such as a remote server or cloud-based system 108, or the like. Although some examples provided herein are described with reference to a cloud infrastructure, the disclosed subject matter also may be implemented in various other types of networks including local wired and/or wireless networks and associated systems, such as a smart home system as disclosed herein. In some embodiments, the recording devices 102, 104 and 106 may include microphones capable of transmitting digitized audio data to the cloud 108. Although the devices 102, 104 and 106 in FIG. 1 are illustrated as symbols representing video cameras, the recording devices 102, 104 and 106 may include various types of audio or audio-video devices that are capable of communicating with the cloud 108, directly or indirectly. For example, various types of security cameras capable of transmitting audio or audio-video data through wired or wireless links, such as Wi-Fi links, may be implemented as recording devices 102, 104 and 106. Various other types of audio or audio-video devices, such as cloud-capable smart smoke alarms capable of monitoring sounds in a given environment, may also be implemented as recording devices 102, 104 and 106. More generally, any type of sensor as disclosed herein that includes audio and/or video capture capabilities may be used as a recording device 102, 104, or 106. Examples of sensors that may be used as a recording device are described below with respect to FIG. 7.

Referring to FIG. 1, a data storage 110 is provided in the network. The data storage 110 may store raw audio or audio-video data provided by the recording devices 102, 104 and 106 to the cloud 108, as well as processed or summarized data. The network in the example illustrated in FIG. 1 also may include one or more servers 112 which provide user-specific summarizations of audio or audio-video data for various users. A user device 114 may provide presentation of a user-specific summary of an audio or audio-video event to a user. The user device 114 may be any device capable of audio or audio-video presentations, including but not limited to a user terminal, a desktop computer, a laptop computer, a tablet, a wireless telephone or smartphone, or a smartwatch, for example. Although FIG. 1 illustrates one user device 114, multiple user devices may communicate with the cloud 108 and present summarized audio or audio-video events to various users. For example, any user device capable of interfacing with a smart home system as disclosed herein may be used as the user device 114.

In some embodiments, the recording devices 102, 104 and 106 may have cloud-recording capability, and audio summaries may be generated by the servers 112 according to the specific requirements or desired of each individual user. That is, the recording devices 102, 104, 106 may be able to record audio or audio-video data directly to a cloud-based storage or processing system. For example, an audio or audio-video recording may be summarized based on a particular sound signature pursuant to the requirement or specification of a particular user. As a specific example, a user may select or provide a sound signature, such as the sound of a child crying. In other examples, various types of sound signatures may include the sound of a human speech, the sounds made by pets, such as dog barks and cat meows, the sounds associated with unauthorized entries, such as sounds of glass breaking or door slamming, or sounds characteristic of a given location or environment. The sound signature may be identified by the user via a selection of an existing audio file, by the user providing a copy of the audio file, or the like. Alternatively or in addition, a system such as a smart home system may provide the user with one or more sound signatures that have been identified by the system, and allow the user to identify one or more of the sound signatures as being of interest to the user. In some implementations, potential sound signatures may be automatically identified by the system, such as where a smart home system has identified known sounds such as glass breaking, a pet noise, a child crying or talking, or the like. In another example, an audio or audio-video recording may be summarized based on the identity of the speaker. For example, a smart home system as disclosed herein may store a voiceprint or other user-specific sound signature of a user that is known to the smart home system. The user-specific sound signature may be used as the sound signature as disclosed herein. In various implementations, sound signatures associated with particular sources, for example, a specific sound signature associated with crying, laughing or speech of a particular child or a specific sound signature associated with a particular pet, may be identified by the user or by the system. In yet another example, an audio or audio-video recording may be summarized based on the location of the sound source. In other examples, summaries of audio or audio-video recordings may be generated based on various requirements of various users.

In the example of the network illustrated in FIG. 1, audio or audio-video data from the recording devices 102, 104 and 106 as previously described may be uploaded to the cloud 108 and stored in the data storage 110. As illustrated in FIG. 1, one or more servers 112 may process raw audio or audio-video data provided by one or more of the recording devices 102, 104 and 106 for summarization as disclosed herein. The audio or audio-video processed and summarized by the servers 112 then may be provided through the cloud 108 to a user device 114, which presents the processed and summarized audio or audio-video to the user. In some embodiments, a local computing system may be used in conjunction with, or instead of, the cloud-based system 108, 110. For example, a component of a smart home system may perform the same functions, whether physically located locally or remotely relative to the premises.

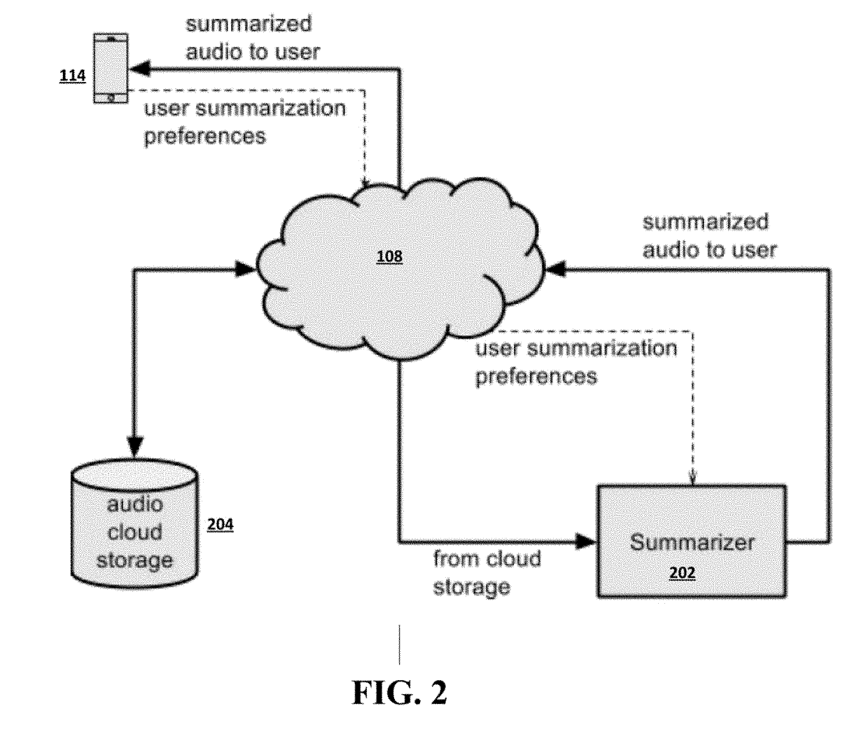

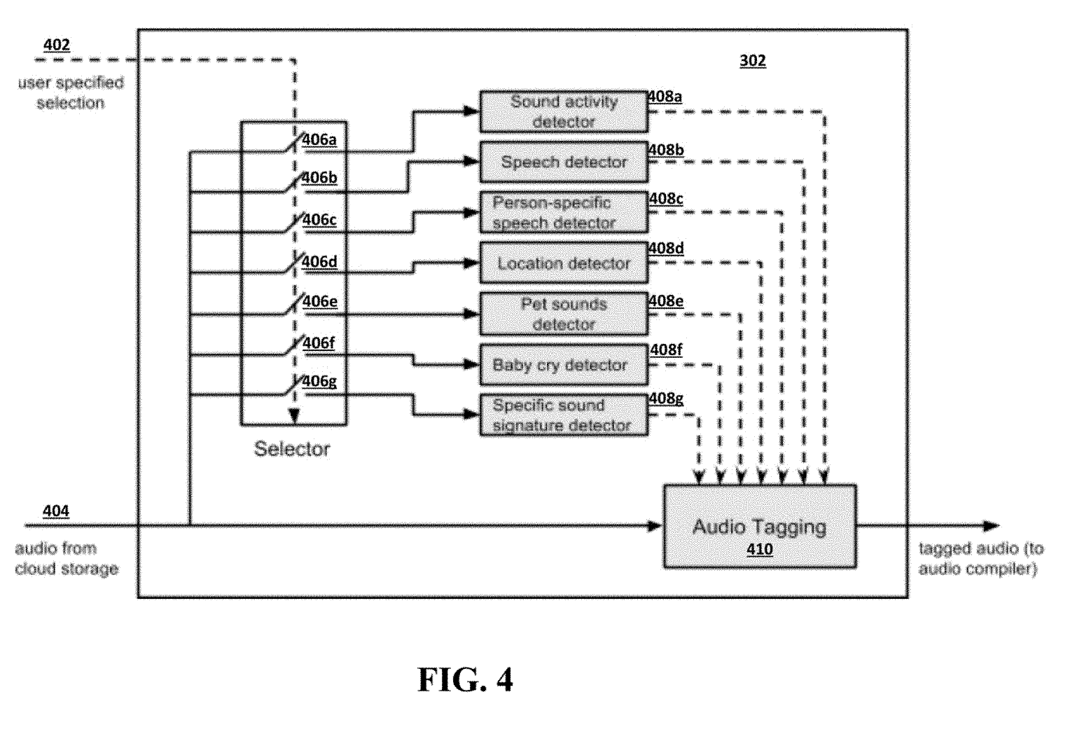

FIG. 2 shows a block diagram illustrating a more specific example of a summarizer as disclosed herein. In the example illustrated in FIG. 2, the user device 114 transmits user preferences to the cloud 108, which passes the user summarization references to a summarizer 202. User preferences may include, for example, one or more types of sound signatures associated with various types of sounds, such as human speeches, baby cries, pet sounds, sounds associates with specific types of locations or environments, or specific sound signatures associated with individual persons or pets. In some implementations, the user preferences may include one or more user specified selections of sound detectors for detecting types of sounds, such as human speeches, baby cries, pet sounds, or location-specific sounds, based on their respective sound signatures. Examples of sound detectors will be described in further detail below with respect to FIG. 4. In an embodiment, the summarizer 202 may be implemented in one or more of the servers 112 as shown in FIG. 1. Referring to FIG. 2, an audio storage 204 provides storage of raw and processed audio data in the cloud 108. In an embodiment, the audio storage 204 may be part of the data storage as shown in FIG. 1. The summarizer may be implemented on a remote and/or cloud-based system, or on a local system as previously described with respect to the cloud-based system.

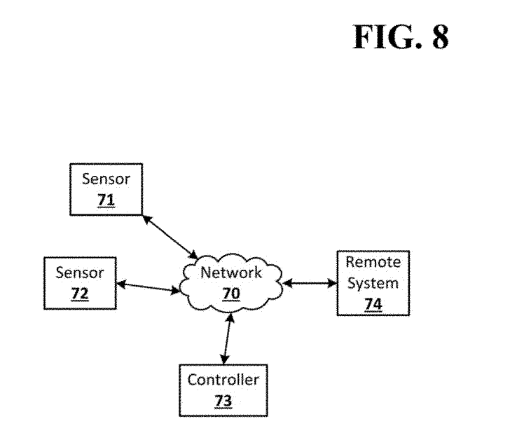

In the example shown in FIG. 2, the summarizer 202 is shown as receiving both user preferences and raw audio data from the cloud 108. More generally, a summarizer 202 as disclosed herein may receive the summarization preferences and/or the raw audio data from any other suitable source as disclosed herein. For example, the summarizer may receive raw audio data directly from a component of a smart home system such as a base station or a sensor. A smart home system may include a sensor network, an example of which will be described in further detail below with respect to FIG. 8. As another example, the summarizer may receive summarization preferences directly from a user via a user device as previously described, or from a component of a smart home system such as a sensor or central base station. The summarizer 202 may be provided raw audio data over a given timespan, for example, to cover a segment of time in an audio recording. User preferences provided by the user device 114 are also provided to the summarizer 202. In an embodiment, multiple user devices may provide multiple sets of user preferences for multiple users to the cloud 108 or to a smart home system as disclosed herein, which may in turn pass these multiple sets of user preferences to the summarizer 202 for generating summarized audio recordings for these users.

The summarizer 202 may transmit the summarized audio recordings to a network, such as a smart home system, a local system or a cloud network 108, which may store one or more copies of such recordings in the audio storage 204. In addition, summarizer may transmit, directly or through the network, a summarized audio recording, that is, a shortened version of the raw audio recording produced by enhancing one or more segments of the raw audio recording or suppressing one or more other segments of the raw audio recording based on the user preferences, to the user device 114. In an embodiment, only the audio data in an audio-video recording is summarized, and a shortened audio-video clip is provided by processing only the audio portion of the audio-video recording based on the user preferences. In an embodiment, upon summarization of the audio data, segments of raw video data corresponding to retained segments audio data are retained, whereas segments of raw video data corresponding to segments of raw audio data suppressed or discarded by the audio summarization process are suppressed or discarded.

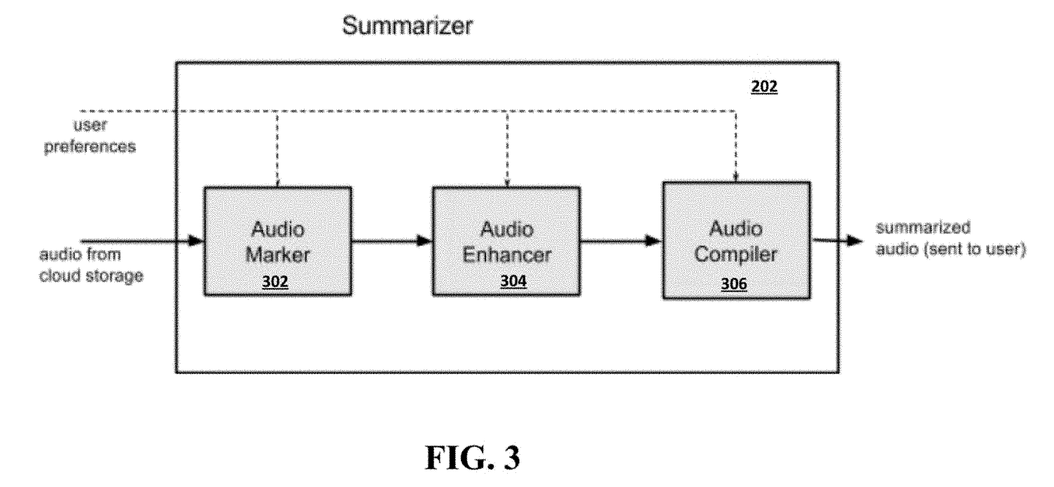

FIG. 3 shows a block diagram illustrating an example of an audio summarizer. In FIG. 3, the audio summarizer 202 includes an audio marker 302, an audio enhancer 304, and an audio compiler 306 connected in a series or cascade. In an embodiment, raw audio data from network storage is provided to the audio marker 302, which tags relevant portions of the raw audio data that need to be presented to the user based on user preferences. A portion or segment of audio data is said to be tagged when a marking or tag is applied to designate that portion or segment as including one or more types of sounds matching one or more sound signatures specified by the user preferences. In some implementations, tagging of portions or segments of an audio recording may be achieved by providing a separate data stream or a separate set of data designating the desired time segments, such as the start and end times of the desired time segments, that may be of interest to the user based on the user preferences. In some implementations, tagging of portions or segments of an audio data stream may be achieved by implanting data bits or words designating the desired time segments within the audio data stream. In an embodiment, user preferences may be provided to a network, such as a cloud 108, by the user through the user device 114 as shown in FIGS. 1 and 2. Alternatively, user preferences may be provided to the network through other input devices. The network may also collect user preferences from multiple users and store those preferences somewhere in the network, for example, the storage 110 or the bank of servers 112 as shown in FIG. 1.

Referring to FIG. 3, the audio enhancer 304, which is connected to the audio marker 302, may enhance the quality of the audio. For example, the quality of portions of the audio data tagged by the audio marker 302 may be enhanced by filtering noise from the audio. In another example, the audio enhancer 304 may enhance the quality of the audio by separating different types of sounds in the frequency domain according to characteristic signatures of different types of sounds, for example, by separating dog barks from human conversation.

In an embodiment, the audio enhancer 304 may be designed make the audio more presentable based on the preference of a specific user. For example, a user may want to hear a conversation that is louder and crisper than what is present in the raw audio, and the audio enhancer 304 may create a richer audio quality experience by enhancing the relevant portions of the tagged raw audio data. Audio enhancement may be achieved by suppressing noise and other artifacts in the sound stream that are not included in the user's list of sound events. Other audio enhancement techniques, for example, frequency domain based techniques that suppress or mask out irrelevant or undesirable sound features, or audio signals with undesirable types of signatures, may also be incorporated. More generally, portions of the audio that are related to a sound signature selected by a user may be emphasized or enhanced, while potions of the audio that detract from or are unrelated to a sound signature selected by a user may be deemphasized, removed, or the like. As a specific example, if a user has indicated interest in a particular speaker's voice, all other voices identified in the audio may be removed, reduced in volume, or the like, so as to emphasize the desired speaker's voice in the audio. As a specific example, the audio may be played with a certain type of sound emphasized or enhanced based on the event score for the user's preferred detector, but in a temporal or chronological order.

Alternatively, the tagged portions of the audio data may be passed directly to the audio compiler 306 without enhancement by the audio enhancer 304. In an embodiment, the audio compiler 306 receives the tagged portions of the audio data, with or without enhancement by the audio enhancer 304, and arranges the tagged portions of the audio data in a manner that is presentable and comprehensible to the user as a summarized output audio data stream in a relatively short amount of time compared to the entire length of the raw audio data stream.

FIG. 4 shows a block diagram illustrating an example of an audio marker. In FIG. 4, the audio marker 302 includes an input 402 for receiving a user specified selection of detector type, which may be part of user preferences as described above. The audio marker 302 also includes an input 404 for receiving raw audio data from the audio data storage as shown in FIG. 3. In the embodiment illustrated in FIG. 4, the audio marker 302 includes selectors 406a, 406b, . . . 406g, which may be arranged in parallel, and detectors 408a, 408b, . . . 408g coupled to the selectors 406a, 406b, . . . 406g, respectively, for detecting specific types of sound. Depending on the user specified selection input 402, the raw audio data from the input 404 may be transmitted to one or more selectors 408a, 408b, . . . 408g.

In the example illustrated in FIG. 4, the detectors include a sound activity detector 408a, a speech detector 408b, a person-specific speech detector 408c, a location detector 408d, a pet sound detector 408e, a baby cry detector 408f, and another type of specific sound signature detector 408g. Various other types of sound detectors may also be implemented within the scope of the disclosure. In an embodiment, a positive output from one of the detectors 408a, 408b, . . . 408g selected by one of the corresponding selectors 406a, 406b, 406g to detect a certain type of sound from the raw audio data is fed to an audio tagger 410. The audio tagger 410 creates a corresponding detector tag or marker and applies the tag or marker to one or more portions of the raw audio data and transmits tagged audio data to the audio compiler 306, either directly or through the audio enhancer 304, as shown in FIG. 3. For example, the audio tagger may generate a file that lists the identified portions of the raw audio data, such as by timestamp, and associates each portion with a tag that links the portion to the detected sound signature.

In an embodiment, the user preferences may include more than one user specified selection to activate more than one of the selectors 406a, 406b, . . . 406g to activate more than one of the detectors 408a, 408b, . . . 408g. For example, a user may wish to detect pet sounds and baby cries by activating the pet sound detector 408e and the baby cry detector 408f but not activating the detectors for other types of sounds. In that situation, user specified selection input 402 may activate two of the selectors 406e and 406f, and the pet sound detector 408e and the baby cry detector 408f may send positive signals to the audio tagger 410 to tag only portions of the raw audio data stream that include sounds associated with pet sounds or baby cries.

In addition to the examples of sound detectors illustrated in FIG. 4 and described above, various other types of sound detectors may also be implemented in an audio marker, including, for example, a laugh detector, a music detector, a siren detector, etc. In an embodiment, sound detectors may be configured to detect the types of sounds based on sound signatures usually associated with certain activities or environments. For example, sound signatures for typical human speeches may be different from sound signatures for typical baby cries, which may be different from sound signatures for typical pet sounds. In some embodiments, the user may select a generic description associated with a generic type of sound signature, such as human speech, baby crying or dog barking, for example. In some embodiments, the user may select a specific sound signature, such as speeches by a particular person, cries of a particular baby, or sounds made by a particular pet, for example. In some embodiments, the user may capture a sound and store it for later use as a signature, and the audio summarizer may use the stored signature for comparison with sounds in the raw audio data stream and tag those portions of the raw audio data stream that match the stored signature. In some embodiments, the audio summarizer may be trained to detect a sound that may appear to be of interest to the user based on pre-stored parameters associated with the user, for example, and may request the user to confirm whether the user wishes to use the detected sound of interest as a signature. In some embodiments, the audio summarizer may detect multiple types of sounds that may be of interest to the user, and may ask the user for disambiguation, that is, to select one type of sound to be used as a signature.

In an embodiment, one or more of the detectors 408a, 408b, . . . 408g in FIG. 4 may be an adaptive sound detector, which may be trained by a user to recognize sounds that are specific to a specific person, apparatus or environment. For example, one or more of the detectors 408a, 408b, . . . 408g may be trained to recognize sounds that are specific to each home, such as the speech of a particular person or persons in a family, door bell, home alarm, door knock, etc. In an embodiment, one or more of the recording devices 102, 104 and 106 in FIG. 1 may include multiple microphones. With multiple microphones placed at different locations in a given environment, direction-of-arrival information for a detected sound may be derived, and audio data may be summarized based at least in part on the location of the sound source. For example, the sound source may be detected by the location detector 408d as shown in FIG. 4.

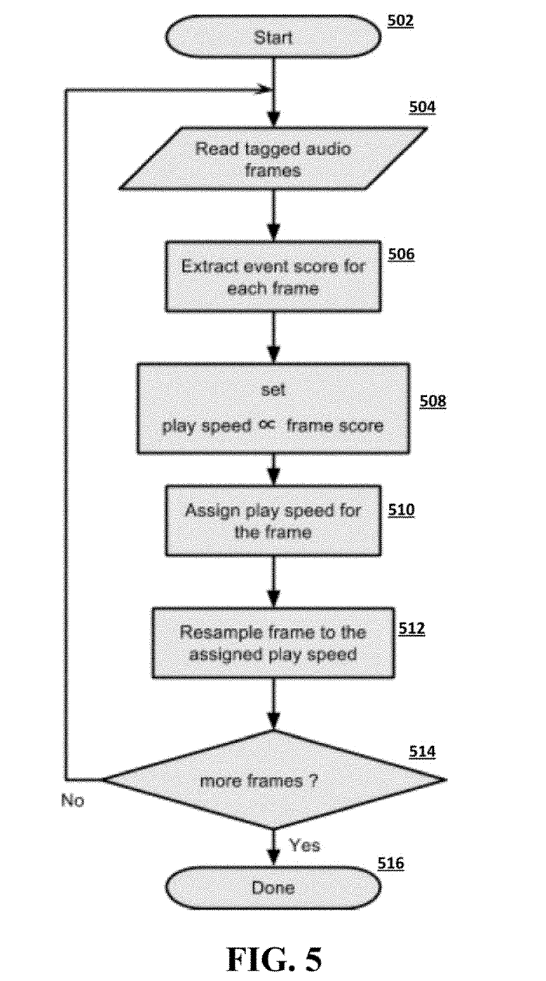

In various embodiments, methods are provided to generate summarized output audio or audio-video streams depending on the level of complexity desired by the application. FIG. 5 shows a flowchart illustrating an example of a process of generating a summarized output audio stream. Such a process may be performed by the audio compiler 306 in FIG. 3, for example. Referring to FIG. 5, the process starts in block 502. An audio recording may be divided into multiple audio frames, each of which is a segment of the audio recording. The frames into which the audio file is divided may be of equal time duration. Alternatively, different audio frames in a given audio recording may not necessarily have equal time durations. A segment of time of an audio recording may also be referred to as an audio clip. An audio frame is said to be tagged if it is designated as an audio frame of interest based on one or more of the user preferences. Tagged audio frames are read in block 504. The tagged audio frames may be generated by the audio marker 302 in FIG. 3, and may be optionally enhanced by the audio enhancer 304 in FIG. 3, for example.

In an embodiment, tagged audio data may be concatenated and played out at the normal speed, or alternatively, at an increased speed, for example, at 1.5 times or 2 times the normal speed of play. In an embodiment, the speed of play may be variable, that is, adaptive to the probability of the tagged events. For example, referring to FIG. 5, after the tagged audio frames are read in block 504, the event score for each of the tagged audio frames is extracted in block 506. In an embodiment, the event score is a parameter or number that is related to the probability of occurrence of an audio event within a given length of audio recording, such as a frame. For example, the event score for human speech in a given frame may be related to the probability of presence of human speech in that frame. In some implementations, the event score for a particular event may be proportional to the probability of that event in the tagged audio frame.

In an embodiment, the playing speed of tagged audio data in a given frame may be set in inverse proportion to the event score for the frame in block 508. A specific playing speed may be assigned to each of the tagged audio frames based on the event score for each tagged audio frame in block 510. Thus, the playing speeds may be different for different tagged audio frames. In this embodiment, a tagged audio frame having a lower event score is played at a higher speed, whereas a tagged audio frame having a higher event score is played at a lower speed. In other words, frames that contain no audio events or a relatively small amount of audio events desired to be heard by the user are played at a higher speed over a shorter period of time, whereas frames that contain a large amount of audio events desired to be heard by the user are played at a normal speed over a longer period of time. By playing audio frames with high event scores at a normal speed and playing audio frames with low event scores at a faster speed, the audio events that have high probabilities of containing sounds signatures of interest as indicated by the user preferences are emphasized over audio events that have low probabilities of containing sound signatures of interest. In block 512, a tagged audio frame is resampled to the playing speed assigned to that particular tagged audio frame.

After a tagged audio frame is resampled to its assigned playing speed in block 512, a determination is made as to whether one or more tagged audio frames are being passed to the audio compiler in block 514. If no more frames are detected in block 514, then the process ends in block 516. If one or more frames are detected in block 514, then the process repeats by reading additional tagged audio frames in block 504.

In an embodiment, the playing speed of a particular tagged audio frame may depend on the type of sound detected and tagged by the audio marker 302 as shown in FIG. 3. Tagging of audio frames may be performed by the audio tagger 410 based on the selection of one or more of the detectors 408a, 408b, . . . 408g in response to user-specified selection as part of user preferences as shown in FIG. 4. For example, if the goal of the user is to summarize speech, then the playing speeds of tagged audio frames that have lower scores for speech events may be increased, whereas the playing speeds of tagged audio frames that have high scores for speech events may be decreased.

In an embodiment, instead of varying the speed of play of tagged audio data, the tagged audio data may be concatenated and divided into shorter clips of approximately equal lengths. For example, an audio recording containing tagged audio data having a total length of one minute may be divided into six clips of ten seconds each. Each of the clips need not have exactly the same length. For example, some of the clips may have a length of nine seconds while some of the other clips may have a length of eleven seconds without seriously affecting the hearing experience of the user. All of these shorter clips of tagged audio data may be played concurrently. The volume of each clip may be gradually increased and then decreased one by one, for example. The volume of a given audio clip may be increased by an amount that is loud enough to move that audio clip into the foreground, but not loud enough to mask out the other clips in the background.

In an embodiment, by increasing the volume of one clip while decreasing the volumes of other clips and repeating the process for each of the clips successively, the discrimination capability of a human brain may be utilized to track sounds even after they move from the foreground to the background. Thus, audio clips that have high probabilities of containing sound signatures of interest may be emphasized over audio clips that have low probabilities of containing sound signatures of interest. Moreover, if multiple loudspeakers are provided, the human brain may be able to discriminate the sounds more effectively by playing clips that are similar to one another from different loudspeakers.

In an embodiment, the starting time of each of the tagged clips may be adjusted in such a manner that little or no overlap occurs between the tagged clips covering events that have high event scores. When the clips are being playing out, the sound volume may be increased only for portions of the clips that have high event scores. Other techniques may also be applied to minimize overlaps between audio clips which include events that have high event scores. For example, the length of each of the clips may be adjusted to minimize the overlap of high scoring events between the clips. In another example, the user may be allowed to intervene or to override automatic playing of the clips to enable a particular clip in the foreground that sounds interesting to continue playing.

In an embodiment, if the audio is part of an audio-video stream provided by a recording device, the video portion of the audio-video stream may be utilized to help guide the user on what is being heard. For example, the video portion of the audio-video stream may provide additional context to the sound that is being heard. In an embodiment, the tagged audio-video data may be concatenated and then divided into shorter clips. These shorter clips of tagged audio-video data may be played out simultaneously. The volume of the audio portion of each clip may be gradually increased and then decreased one by one, for example.

In an embodiment, the volume of the audio portion of a given clip may be increased by an amount that is loud enough to move that clip into the foreground, but not loud enough to mask out the other clips in the background. At the same time, the corresponding video portion of each tagged audio-video clip may be enhanced and faded in a manner that matches the increase and decrease in the volume of the audio portion. The increase and decrease of sound volume and the enhancement and fading of the corresponding video may be repeated for each of the clips successively.

In an embodiment, the tagged audio-video clips may be aligned such that the high scoring events have little or no overlap between the clips. For example, overlaps between tagged audio-video clips may be minimized by varying the starting time or the length of each clip. Moreover, both the audio and video portions of audio-video clips may be enhanced over the high scoring event. In some implementations, it may be easier to detect certain types of sounds by sound detectors, such as detectors 408a, 408b, . . . 408g in the audio marker 302 of FIG. 4, based on characteristic sound signatures, than complex image processing required for recognizing certain types of images in a video. Moreover, it may be easier to compile and summarize audio data based on event scores of sound events than compiling and summarizing video data. In some implementations, audio-video streams can be summarized or shortened by tagging and compiling the audio portions of the audio-video streams based on the user's audio preferences and event scores.

Summarized audio or audio-video data may be presented to the user in various manners. For example, the summarized audio or audio-video data may be stored in a storage, for example, the storage 204 in the network as shown in FIG. 2, and may be retrieved by the user on demand. In one example, the user may retrieve the summarized audio or audio-video from the storage 204 and play back the summarized audio or audio-video on the user device 114 as shown in FIG. 2. Alternatively, the summarized audio or audio-video may be stored on the user device 114 itself. Such a user device may be a mobile device or a home device, including but not limited to a mobile telephone, a tablet, a laptop computer, a desktop computer, a stereo system, or a television set, for example. The user may retrieve the summarized audio or audio-video through a user interface. For example, the user may open an application by touching an icon on a touchscreen of a mobile device, a computer or a television set, or pressing a hard or soft button. In some embodiments, instead of user-activated playback of summarized audio or audio-video, a timer may be programmed to play the summarized audio or audio-video at a preset time, for example, as an alarm. The summarized audio or audio-video may be accessed in various manners. For example, the user interface may include a functionality for indicating, on the side, the bottom, or in an overlay, where or when each sound signature was detected while the summarized audio-video clip is being played, or a functionality for displaying a progress bar for the audio-video clip with a bookmark at each detected sound. In some implementations, the user may select, on the user interface, whether to display or to hide bookmarks or indications of detected sound signatures while the audio-video clip is being played.

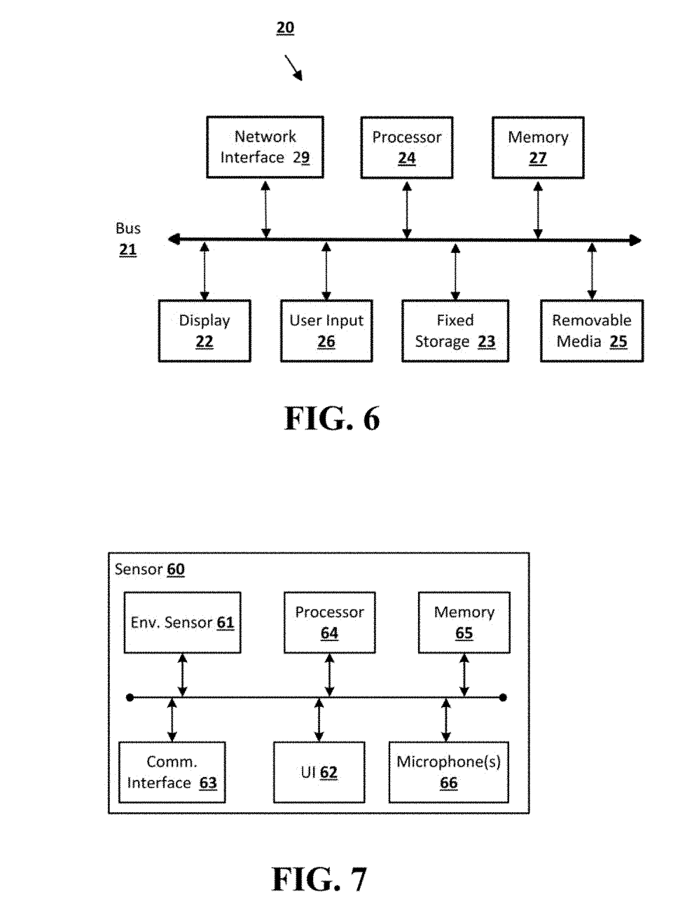

Embodiments of the presently disclosed subject matter may be implemented in and used with a variety of component and network architectures. For example, the bank of servers 112 as shown in FIG. 1 may include one or more computing devices for implementing embodiments of the subject matter described above. FIG. 6 shows an example of a computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor or an Application Specific Integrated Circuit (ASIC) that embodies all or part of the techniques according to embodiments of the disclosed subject matter in hardware or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

In some embodiments, the recording devices 102, 104 and 106 as shown in FIG. 1 may include one or more sensors. These sensors may include microphones for sound detection, for example, and may also include other types of sensors. In general, a “sensor” may refer to any device that can obtain information about its environment. Sensors may be described by the type of information they collect. For example, sensor types as disclosed herein may include motion, smoke, carbon monoxide, proximity, temperature, time, physical orientation, acceleration, location, entry, presence, pressure, light, sound, and the like. A sensor also may be described in terms of the particular physical device that obtains the environmental information. For example, an accelerometer may obtain acceleration information, and thus may be used as a general motion sensor or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a smart home environment. For example, a sensor may operate as a security sensor when it is used to determine security events such as unauthorized entry. A sensor may operate with different functions at different times, such as where a motion sensor is used to control lighting in a smart home environment when an authorized user is present, and is used to alert to unauthorized or unexpected movement when no authorized user is present, or when an alarm system is in an “armed” state, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a home security system or a smart home environment, or as otherwise directed by such a system.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, or other sensors. Such a housing also may be referred to as a sensor or a sensor device. For clarity, sensors are described with respect to the particular functions they perform or the particular physical hardware used, when such specification is necessary for understanding of the embodiments disclosed herein.

A sensor may include hardware in addition to the specific physical sensor that obtains information about the environment. FIG. 7 shows an example of a sensor as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, pressure sensor, microphone, or any other suitable environmental sensor, that obtains a corresponding type of information about the environment in which the sensor 60 is located. A processor 64 may receive and analyze data obtained by the sensor 61, control operation of other components of the sensor 60, and process communication between the sensor and other devices. The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices. A user interface (UI) 62 may provide information or receive input from a user of the sensor. The UI 62 may include, for example, a speaker to output an audible alarm when an event is detected by the sensor 60. Alternatively, or in addition, the UI 62 may include a light to be activated when an event is detected by the sensor 60. The user interface may be relatively minimal, such as a limited-output display, or it may be a full-featured interface such as a touchscreen. Components within the sensor 60 may transmit and receive information to and from one another via an internal bus or other mechanism as will be readily understood by one of skill in the art. Furthermore, the sensor 60 may include one or more microphones 66 to detect sounds in the environment. One or more components may be implemented in a single physical arrangement, such as where multiple components are implemented on a single integrated circuit. Sensors as disclosed herein may include other components, or may not include all of the illustrative components shown.

Sensors as disclosed herein may operate within a communication network, such as a conventional wireless network, or a sensor-specific network through which sensors may communicate with one another or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another. FIG. 8 shows an example of a sensor network as disclosed herein, which may be implemented over any suitable wired and/or wireless communication networks. One or more sensors 71, 72 may communicate via a local network 70, such as a Wi-Fi or other suitable network, with each other and/or with a controller 73. The controller may be a general- or special-purpose computer. The controller may, for example, receive, aggregate, and/or analyze environmental information received from the sensors 71, 72. The sensors 71, 72 and the controller 73 may be located locally to one another, such as within a single dwelling, office space, building, room, or the like, or they may be remote from each other, such as where the controller 73 is implemented in a remote system 74 such as a cloud-based reporting and/or analysis system. Alternatively or in addition, sensors may communicate directly with a remote system 74. The remote system 74 may, for example, aggregate data from multiple locations, provide instruction, software updates, and/or aggregated data to a controller 73 and/or sensors 71, 72.

The sensor network shown in FIG. 8 may be an example of a smart-home environment. The depicted smart-home environment may include a structure, a house, office building, garage, mobile home, or the like. The devices of the smart home environment, such as the sensors 71, 72, the controller 73, and the network 70 may be integrated into a smart-home environment that does not include an entire structure, such as an apartment, condominium, or office space.

The smart home environment can control and/or be coupled to devices outside of the structure. For example, one or more of the sensors 71, 72 may be located outside the structure, for example, at one or more distances from the structure (e.g., sensors 71, 72 may be disposed outside the structure, at points along a land perimeter on which the structure is located, and the like. One or more of the devices in the smart home environment need not physically be within the structure. For example, the controller 73 which may receive input from the sensors 71, 72 may be located outside of the structure.

The structure of the smart-home environment may include a plurality of rooms, separated at least partly from each other via walls. The walls can include interior walls or exterior walls. Each room can further include a floor and a ceiling. Devices of the smart-home environment, such as the sensors 71, 72, may be mounted on, integrated with and/or supported by a wall, floor, or ceiling of the structure.

The smart-home environment including the sensor network shown in FIG. 8 may include a plurality of devices, including intelligent, multi-sensing, network-connected devices, that can integrate seamlessly with each other and/or with a central server or a cloud-computing system (e.g., controller 73 and/or remote system 74) to provide home-security and smart-home features. The smart-home environment may include one or more intelligent, multi-sensing, network-connected thermostats (e.g., “smart thermostats”), one or more intelligent, network-connected, multi-sensing hazard detection units (e.g., “smart hazard detectors”), and one or more intelligent, multi-sensing, network-connected entryway interface devices (e.g., “smart doorbells”). The smart hazard detectors, smart thermostats, and smart doorbells may be the sensors 71, 72 shown in FIG. 8.

A user can interact with one or more of the network-connected smart devices (e.g., via the network 70). For example, a user can communicate with one or more of the network-connected smart devices using a computer (e.g., a desktop computer, laptop computer, tablet, or the like) or other portable electronic device (e.g., a smartphone, a tablet, a key FOB, and the like). A webpage or application can be configured to receive communications from the user and control the one or more of the network-connected smart devices based on the communications and/or to present information about the device's operation to the user. For example, the user can view can arm or disarm the security system of the home.

One or more users can control one or more of the network-connected smart devices in the smart-home environment using a network-connected computer or portable electronic device. In some examples, some or all of the users (e.g., individuals who live in the home) can register their mobile device and/or key FOBs with the smart-home environment (e.g., with the controller 73). Such registration can be made at a central server (e.g., the controller 73 and/or the remote system 74) to authenticate the user and/or the electronic device as being associated with the smart-home environment, and to provide permission to the user to use the electronic device to control the network-connected smart devices and the security system of the smart-home environment. A user can use their registered electronic device to remotely control the network-connected smart devices and security system of the smart-home environment, such as when the occupant is at work or on vacation. The user may also use their registered electronic device to control the network-connected smart devices when the user is located inside the smart-home environment.

Moreover, the smart-home environment may make inferences about which individuals live in the home and are therefore users and which electronic devices are associated with those individuals. As such, the smart-home environment may “learn” who is a user (e.g., an authorized user) and permit the electronic devices associated with those individuals to control the network-connected smart devices of the smart-home environment, in some embodiments including sensors used by or within the smart-home environment. Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services or communication protocols.

A smart-home environment may include communication with devices outside of the smart-home environment but within a proximate geographical range of the home. For example, the smart-home environment may communicate information through the communication network or directly to a central server or cloud-computing system regarding detected movement or presence of people, animals, and any other objects and receives back commands for controlling the lighting accordingly.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
obtaining a user preference indicating a sound signature of interest to a user;
generating one or more designated audio segments of interest from an input audio stream based on the user preference;
generating an event score for each of the designated audio segments of interest, the event score indicating the probability that an audio event associated with the sound signature occurs within the audio segment; and
generating a summarized output audio stream by applying the event score to each of the designated audio segments of interest to emphasize sounds corresponding to the sound signature of interest to the user over sounds that do not correspond to the sound signature of interest to the user.

2. The method of claim 1, further comprising enhancing audio signals in at least one of the designated audio segments of interest.

3. The method of claim 1, wherein generating one or more designated audio segments of interest comprises selecting at least one of a plurality of detectors based on the user preference.

4. The method of claim 3, wherein generating one or more designated audio segments of interest further comprises detecting at least one of a plurality of types of sound events by at least one of the plurality of detectors selected for detection based on the user preference.

5. The method of claim 3, wherein each of the detectors is configured to detect a type of sound event based on one or more characteristic sound signatures.

6. The method of claim 3, wherein the detectors comprise one or more of:
a sound activity detector;
a speech detector;
a person-specific speech detector;
a location detector;
a pet sound detector;
a baby cry detector; and
a speech sound signature detector.

7. The method of claim 1, wherein generating the summarized output audio stream comprises setting a playing speed of each of the designated audio segments of interest based on the event score for each of the designated audio segments of interest.

8. The method of claim 7, wherein the playing speed for one of the designated audio segments of interest having a lower event score is higher than the playing speed for another one of the designated audio segments of interest having a higher event score.

9. The method of claim 1, wherein generating the summarized output audio stream comprises dividing the designated audio segments of interest into a plurality of clips of approximately equal lengths.

10. The method of claim 9, wherein generating the summarized output audio stream further comprises playing all of the clips concurrently.

11. The method of claim 10, wherein generating the summarized output audio stream further comprises increasing and then decreasing a sound volume of each of the clips one by one.

12. The method of claim 1, wherein the input audio stream is part of an input audio-video stream, and wherein the summarized output audio stream is part of a summarized output audio-video stream.

13. An apparatus comprising:
a memory; and
a processor communicably coupled to the memory, the processor configured to execute instructions to:
obtain a user preference indicating a sound signature of interest to a user;
generate one or more designated audio segments of interest from an input audio stream based on the user preference;
generate an event score for each of the designated audio segments of interest, the event score indicating the probability that an audio event associated with the sound signature occurs within the audio segment; and
generate a summarized output audio stream by applying the event score to each of the designated audio segments of interest to emphasize sounds corresponding to the sound signature of interest to the user over sounds that do not correspond to the sound signature of interest to the user.

14. The apparatus of claim 13, wherein the processor is further configured to execute instructions to enhance audio signals in at least one of the designated audio segments of interest.

15. The apparatus of claim 13, wherein different designated audio segments of interest have different event scores, wherein the instructions to generate the summarized output audio stream comprises instructions to assign different playing speeds for different designated audio segments of interest, and wherein the playing speed for one of the designated audio segments of interest having a lower event score is higher than the playing speed for another one of the designated audio segments of interest having a higher event score.

16. The apparatus of claim 13, wherein the instructions to generate the summarized output audio stream comprises instructions to:
divide the designated audio segments of interest into a plurality of clips of approximately equal lengths;
play all of the clips simultaneously; and
increase and then decrease a sound volume of each of the clips one by one.

17. The apparatus of claim 13, further comprising a plurality of detectors to detect sounds according to sound signatures of interest to the user.

18. The apparatus of claim 17, wherein the detectors comprise one or more of:
a sound activity detector;
a speech detector;
a person-specific speech detector;
a location detector;
a pet sound detector;
a baby cry detector; and
a speech sound signature detector.

19. An apparatus, comprising:
an audio summarizer, comprising:
an audio marker configured to:
obtain a user preference indicating a sound signature of interest to a user; and
generate one or more designated audio segments of interest from an input audio stream based on the user preference; and
an audio compiler configured to:
generate an event score for each of the designated audio segments of interest, the event score indicating the probability that an audio event associated with the sound signature occurs within the audio segment; and
generate a summarized output audio stream by applying the event score to each of the designated audio segments of interest to emphasize sounds corresponding to the sound signature of interest to the user over sounds that do not correspond to the sound signature of interest to the user.

20. The apparatus of claim 19, wherein the audio summarizer further comprises an audio enhancer configured to enhance audio signals in at least one of the designated audio segments of interest, and to transmit the enhanced audio signals to the audio compiler.

21. The apparatus of claim 20, wherein the audio marker comprises:
a plurality of selectors configured to select a plurality of types of sound events, respectively; and
a plurality of detectors coupled to the selectors, respectively, the detectors configured to detect the types of sound events based on characteristic sound signatures associated with the types of sound events, respectively.

22. The apparatus of claim 21, wherein the detectors comprise one or more of:
a sound activity detector;
a speech detector;
a person-specific speech detector;
a location detector;
a pet sound detector;
a baby cry detector; and
a speech sound signature detector.

23. The apparatus of 19, wherein different designated audio segments of interest have different event scores, wherein the audio compiler is configured to assign different playing speeds for different designated audio segments of interest, and wherein the playing speed for one of the designated audio segments of interest having a lower event score is higher than the playing speed for another one of the designated audio segments of interest having a higher event score.

24. The apparatus of claim 19, wherein the audio compiler is configured to:
divide the designated audio segments of interest into a plurality of clips of approximately equal lengths;
play all of the clips simultaneously; and
increase and then decrease a sound volume of each of the clips one by one.
